(19) United States
(12) Patent Application Publication
(10) Pub. No.: US 2019/0122272 A1
(43) Pub. Date: Apr. 25, 2019

(54) USER INTERFACE, SYSTEM AND METHOD FOR AUTOMATIC MATCHING OF PARTIES TO A TRANSACTION PROPOSAL

(71) Applicant: GOLLGI INTERNATIONAL LTD., London (GB)

(72) Inventor: Eitan KOREN, London (GB)

(21) Appl. No.: 16/092,558

(22) PCT Filed: Apr. 9, 2017
(86) PCT No.: PCT/IL2017/050437

§ 371 Date: Oct. 10, 2018

Related U.S. Application Data
(60) Provisional application No. 62/320,544, filed on Apr. 10, 2016.

(51) Int. Cl. G06Q 30/06; G06F 17/27

(52) U.S. Cl. CPC G06Q 30/0609; G06Q 30/0611; G06Q 30/0643; G06F 17/2705

(57) ABSTRACT

The invention provides a system and method for automatic matching of initiator—responder to a transaction proposal, using natural language (NL). The initiator formulates a request for goods/services with their qualifiers he wishes to purchase and responders matching the request are proposed.

### FIELD OF THE INVENTION

The present invention generally related to a computer-implemented system and method for automatic matching of parties to a transaction proposal, and more particularly to a user interface, system and method for automatic matching of parties to a transaction proposal, using natural language (NL).

### BACKGROUND OF THE INVENTION

Natural language (NL) generally refers to the interaction of a user with a computerized system through inputs supplied by the user in a natural language (e.g. human structured syntax).

It allows the user to type (or speak) a phrase specifying the requested information.

U.S. Pat. No. 8,775,322 B2 discloses a system for matching buyers and sellers based on buyers and sellers preferences. Prospective buyers can locate potential sellers based on buyer preferences and sellers characteristics. Prospective sellers can locate potential buyers on seller preferences and characteristics.

US 2003/0004859 discloses a secure, compute based method and system for anonymously and confidentially matching indications of interest from potential buyers and sellers.

### SUMMARY OF THE INVENTION

It is one object of the current invention to disclose a system for automatically matching at least two potential parties to a transaction proposal, the parties comprising an initiator and at least one responder, wherein the system comprises:
a. at least one transaction mediation module for providing transaction mediation services, each transaction mediation module comprising digital data processing means, inter-parties communication means and digital data memory storage;
b. a non-transitory computer readable medium for storing programmed instructions for implementing a transaction mediation algorithm for instructing the at least one transaction mediation module; and
c. a transaction response database of potential responders and potential responder qualifiers, wherein the potential responder qualifiers are comprised of categories of data which are relevant for matching a potential responder to a transaction proposal; and
d. a data repository which is a knowledge base including definitions of goods/services and associated structured data including qualifiers of the goods;

wherein the at least one transaction mediation module is configured by the transaction mediation algorithm to implement:
i. a graphic interface module displaying various user interfaces provided to the initiator and responder;
ii. a registration module to receive a registration request from the initiator and registration request from the responder and authenticate them;
iii. a transaction request receiving module for receiving a transaction request from the initiator, wherein the transaction request comprises a description of goods or services for procurement;
iv. a transaction request interpretation module for parsing the transaction request made in natural language into transaction keywords for identifying
   a. specific goods or services; and
   b. qualifiers of the goods or services;
v. a transaction request matching module for compiling a request provision list from the data repository database, wherein the request response provision list is comprised of matching goods or services computed to match the description of the transaction request;
vi. a transaction request responder module for compiling a responder list from the transaction response database, wherein each entry of the responder list comprised of (a) an identification of a potential responder computed to be capable of providing the matching goods or services, and (b) one or more potential responder qualifiers computed to be relevant to the transaction request ; and,
vii. a transaction reply module for composing and communicating a transaction request reply to the initiator, wherein the transaction request reply comprises information elements from the responder list.

It is another object of the current invention to disclose the system as described above, wherein the initiator is a buyer and the responder is a seller.

It is an object of the present invention to disclose a method for automatically matching at least two potential parties to a transaction proposal, wherein the parties comprise an initiator and at least one responder and the method comprises:
a. providing a data repository which is a knowledge base including definitions of goods/services and associated structured data including qualifiers of the goods;
b. providing a transaction response database of potential responders and potential responder qualifiers, wherein the potential responder qualifiers are comprised of categories of data which are relevant for matching a potential responder to a transaction proposal;
c. displaying various user interfaces provided to the initiator and the responder, by employing a graphical interface module;
d. registering the initiator and the responder, after authenticating them, by employing a registration module;
e. transforming a transaction request made in natural language into a set of structured data in the data repository by employing a transaction request receiving module, a transaction request interpretation module, wherein the transaction request receiving module receives a transaction request from the initiator, wherein the transaction request comprises a description of goods or services for procurement and wherein the transaction request interpretation module parses the transaction request made in natural language into transaction keywords for identifying
   a. specific goods or services; and
   b. qualifiers of the goods or services;
f. compiling a request provision list, computed to match the description of the transaction request by employing a transition request matching module and the data repository database;
g. compiling a responder list wherein each entry of the responder list is comprised of (a) an identification of a potential responder computed to be capable of providing the matching goods or services, and (b) one or more potential responder qualifiers computed to be relevant to the transaction request, by employing a transaction request responder module and the transaction response database; and
h. composing and communicating a transaction request reply to the initiator by employing a transaction reply module, wherein the transaction request reply is comprising information elements from the responder list.

It is another object of the current invention to disclose the method as described, wherein the initiator is a buyer and the responder is a seller.

It is an object of the current invention to disclose a non-transitory computer-readable medium with instructions stored thereon, that when executed by a processor, performs the steps comprising:
a. displaying various user interfaces provided to the initiator and the responder by employing a graphical interface module;
b. registering the initiator and the responder, after authenticating them, by employing a registration module;
c. transforming a transaction request made in natural language into a set of structured data by employing a transaction request receiving module and a transaction request interpretation module, wherein the transaction request receiving module receives a transaction request from the initiator, wherein the transaction request comprises a description of goods or services for procurement and wherein the transaction request interpretation module parses the transaction request made in natural language into transaction keywords for identifying
   specific goods or services; and
   qualifiers of the goods or services;
d. compiling a request provision list, computed to match the description of the transaction request, by employing a transition request matching module and the data repository database;
e. compiling a responder list, wherein each entry of the responder list is comprised of (a) the identification of a potential responder computed to be capable of providing the matching goods or services, and (b) one or more potential responder qualifiers computed to be relevant to the transaction request, by emplying a transaction request responder module and a transaction response database; and
f. composing and communicating a transaction request reply to the initiator by employing a transaction reply module, wherein the transaction request reply is comprising information elements from the responder list.

### BRIEF DESCRIPTION OF THE DRAWINGS

FIG. 1 provides a functional block diagram for an automatic matching of parties to a transaction proposal system in accordance with some embodiments.

FIG. 2 illustrates a flow of information, related to the transaction mediation module in accordance with some embodiments.

FIG. 3 illustrates a flow of information, related to the different sub-modules of the transaction mediation module in accordance with some embodiments.

FIG. 4 is a flowchart for a routine generally illustrative of steps carried out in accordance with some embodiments to match responders to a transaction proposal, responsive to a natural language input by an initiator.

FIG. 5-FIG. 17 are screen shots in accordance with some embodiments of the user interface of the present invention.

### DETAILED DESCRIPTION OF THE PREFERRED EMBODIMENTS

The following is a detailed description of the preferred embodiments. Reference is made to the accompanying drawings that form a part hereof, and in which are shown by way of illustration, specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Although the technology will be described in conjunction with various embodiment(s), it will be understood that they are not intended to limit the present technology to these embodiments. To the contrary, the present technology is intended to cover alternatives, modifications and equivalents which may be included within the spirit and scope of the various embodiments as defined by the appended claims.

In the following description of embodiments, numerous specific details are set forth in order to provide a thorough understanding of the present technology. However, the present technology may be practiced without these specific details. In other instances, well known methods, procedures, components, and circuits have not been described in detail so as not to unnecessarily obscure aspects of the present embodiments.

Definitions

The term “qualifier of responder” refers to any responder additional information related to him (e.g. name, location) and to his goods/services (e.g. time to production, availability, price, payment conditions).

The term “qualifier of goods/services” refers to any goods/service additional details related to the initiator request (e.g. brand, model, size, color, and price)

The Invention

The invention provides a system and method for automatic matching of initiator—responder to a transaction proposal, using natural language (NL). An initiator formulates a request for goods/services with their qualifiers he wishes to purchase and responders matching the request are proposed.

### FIGURES

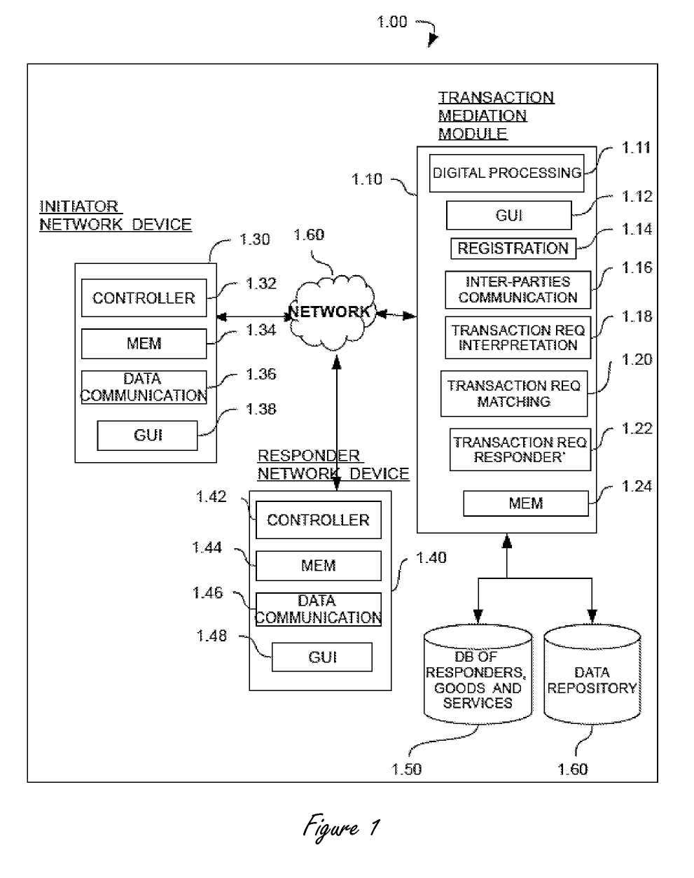

Referring now generally to the figures and particularly to FIG. 1. FIG. 1 depicts an automatic matching of parties to a transaction proposal system 1.0 in accordance with some embodiments. The system includes a number of components including one or more transaction mediation modules 1.10, an initiator network device 1.20, a responder network device 1.30 and two databases: a database of the responders, their products and services 1.40 and a data repository 1.50. The initiator device, responder device and the transaction mediation module(s) communicate over a network 1.60, such as a wide area network, a local area network, a broadband wireless, etc.

The initiator network device is shown to include a controller 1.32, local memory (MEM) 1.34, a data communication means 1.36 and a graphical user interface (GUI) 1.38. The controller may be hardware based or programmable processor which includes top level control of the device responsive to input supplied by the initiator via the GUI. The device memory stores information input by the initiator, programming and control information utilized by the controller and information transferred to the device over the network. The GUI may include a keyboard, keypad, mouse, monitor, touch screen, touch pad and any other suitable component to enable human comprehensive interaction with and/or control of the device.

The responder network device is shown to include a controller 1.42, local memory (MEM) 1.44, a data communication means 1.46 and a graphical user interface (GUI) 1.48. The controller may be hardware based or programmable processor which includes top level control of the device responsive to input supplied by the responder via the GUI. The device memory stores information input by the responder, programming and control information utilized by the controller and information transferred to the device over the network. The GUI may include a keyboard, keypad, mouse, monitor, touch screen, touch pad and any other suitable component to enable human comprehensive interaction with and/or control of the device.

Both devices can take a variety of forms, including but not limited to a desktop computer, a laptop computer, a tablet, a smart phone or some other suitable network accessible platforms.

The transaction mediation module can similarly take a variety of forms, and is shown in FIG. 1 to include a digital processing unit 1.11, a graphical user interface 1.12, a registration module 1.14, an inter-parties communication means 1.16, a transaction request interpretation 1.18, a transaction request matching 1.20, a transaction request responder 1.22 and local memory (MEM) 1.24. While only a single initiator, a single responder and a single transaction mediation module are shown in FIG. 1, it will be appreciated that any number of respective devices and modules can be interconnected and utilized in accordance with the present disclosure.

The data base of responders, products and services 1.50 includes for each responder, the responder qualifiers and a list of services/goods he offers.

The data repository 1.60 is a knowledge base including definitions of goods/services and associated structured data including qualifiers of said goods.

As explained below, an initiator of the initiator device can access the transaction mediation module to generate a request in a natural language.

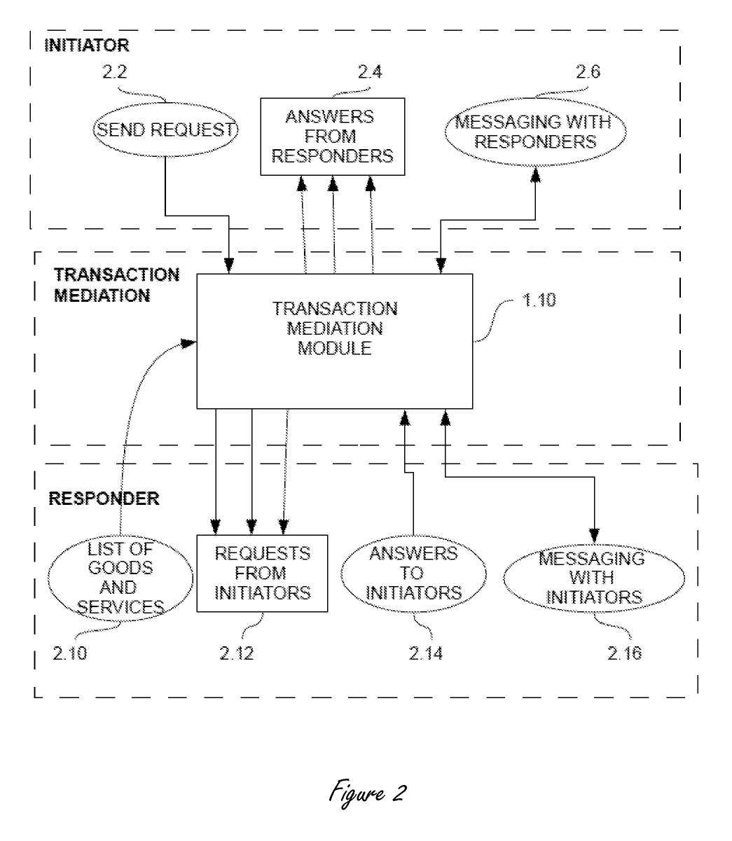

Referring now generally to the figures and particularly to FIG. 2. FIG. 2 illustrates the flow of information, related to the transaction mediation module 1.10 that can be incorporated into the system 1.0 of FIG. 1. As per step 2.2, once the initiator is registered (not shown in the figure), the initiator may send a request for a good/service in a natural language, the transaction mediation module is processing the request (see more details below) and after finding appropriate responders and negotiating between responders and initiators (2.6, 2.16), it sends the initiator request 2.12 to them and forwards the answers of the responders to the initiator (answers from responders 2.4).

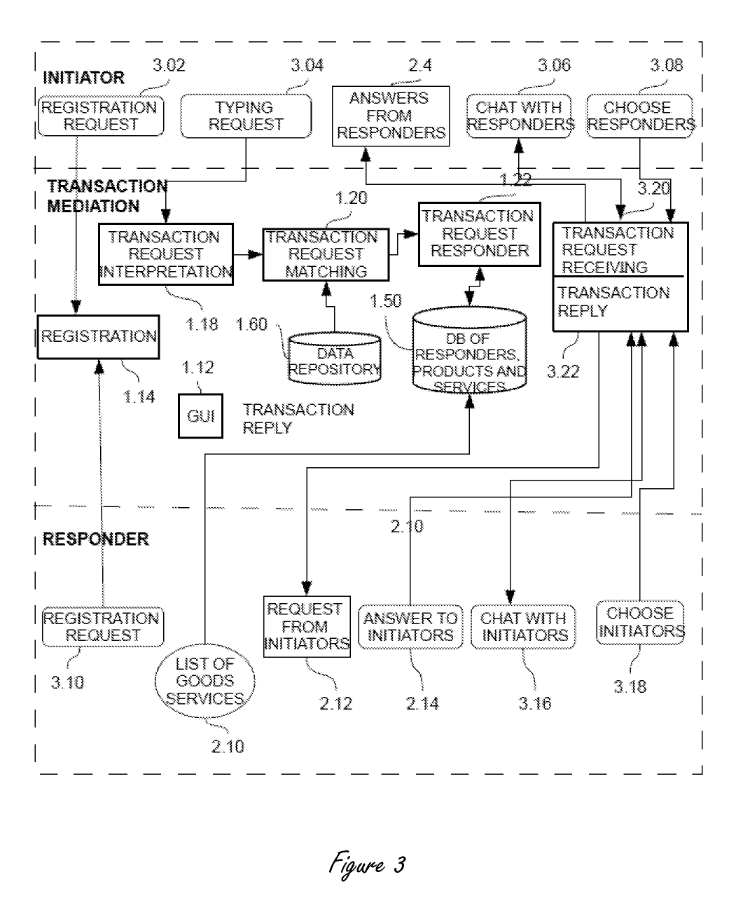

Referring now generally to the figures and particularly to FIG. 3. FIG. 3 illustrates the flow of information, related to the different components of transaction mediation module 1.10, which may be incorporated into the system 1.0 of FIG. 1.

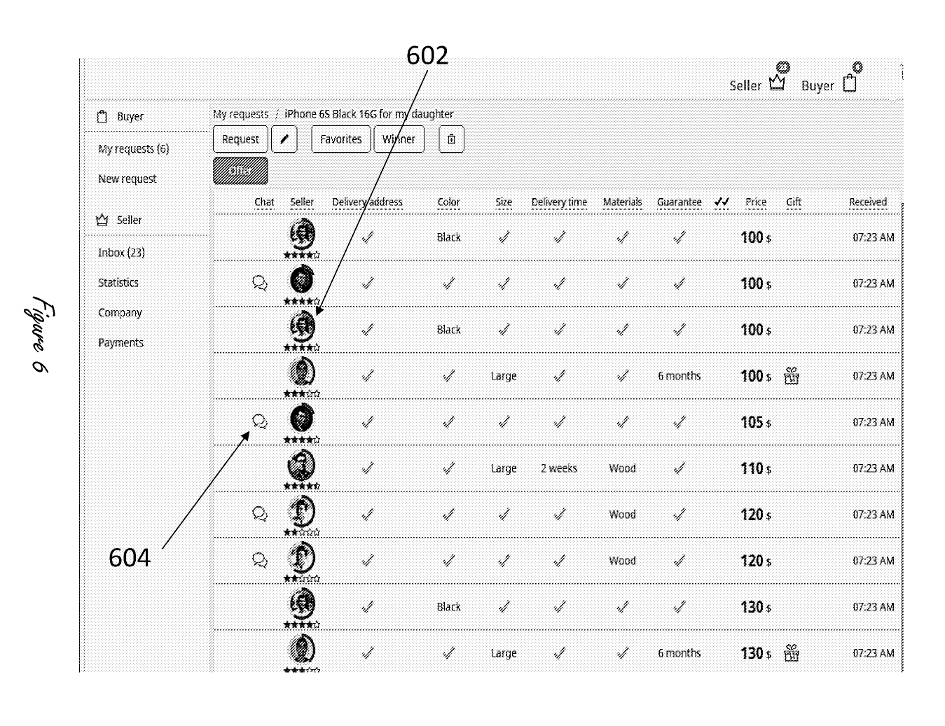

As per step 3.02 and step 3.10, both the initiator and the responder register to the system. A responder is authorized for register only after checking his details e.g. reviews, bank account, method of payment) and a reliability wheel is then created (see below details on FIG. 6). Once the initiator is registered, the initiator may send a request for a good/service in a natural language as per step 3.04, the transaction request receiving component 3.20 is receiving it and forwarding it to the transaction request interpretation 1.18 which parses the transaction request into transaction keywords using a set of algorithms for processing the initiator request, removing irrelevant words and forwards the result to the transaction request matching 1.20. The transaction request matching is then compiling a request provision list, including the matching goods/services appropriate to the initiator request. The list is then forwarded to the transaction request responder 1.22, which compiles a list of potential responders being capable of providing the matching goods/services. An inter-communication process between responders and initiators occurs through the inter-parties communication component using which may include—chat with responders 3.06, chat with initiators 3.16. Once there is an agreement between the initiator and responder, transaction reply component 3.22 communicates the reply (answers from responders 2.14) to the initiator.

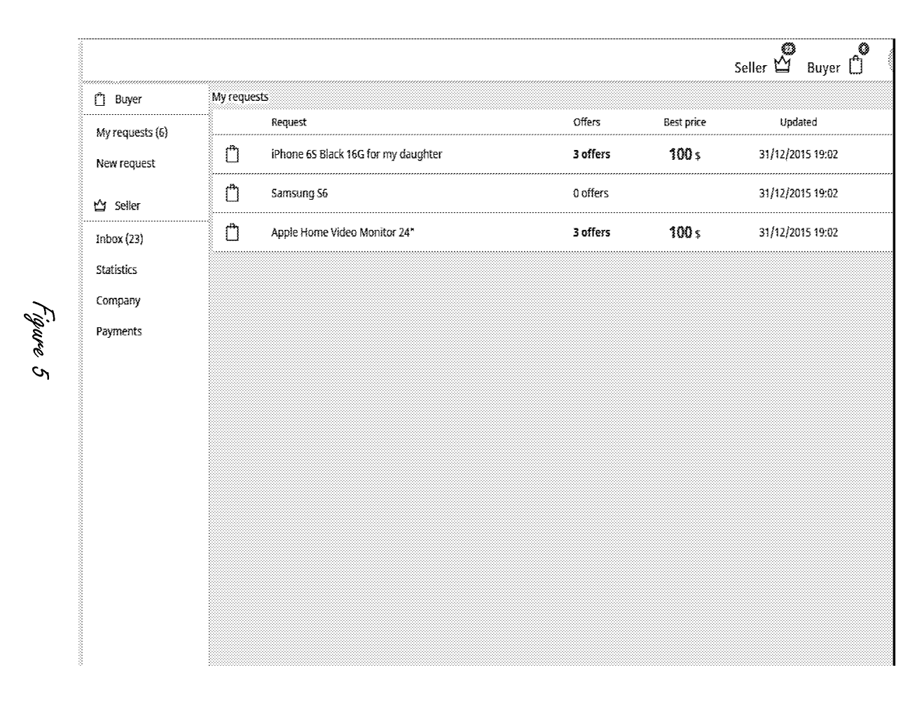

The transaction meditation system provides the interactive link between the initiators and the responders, and display the various user interfaces (GUI 1.12) of the present invention. More details about the various user interfaces are mentioned below (see FIGS. 5-18 details below).

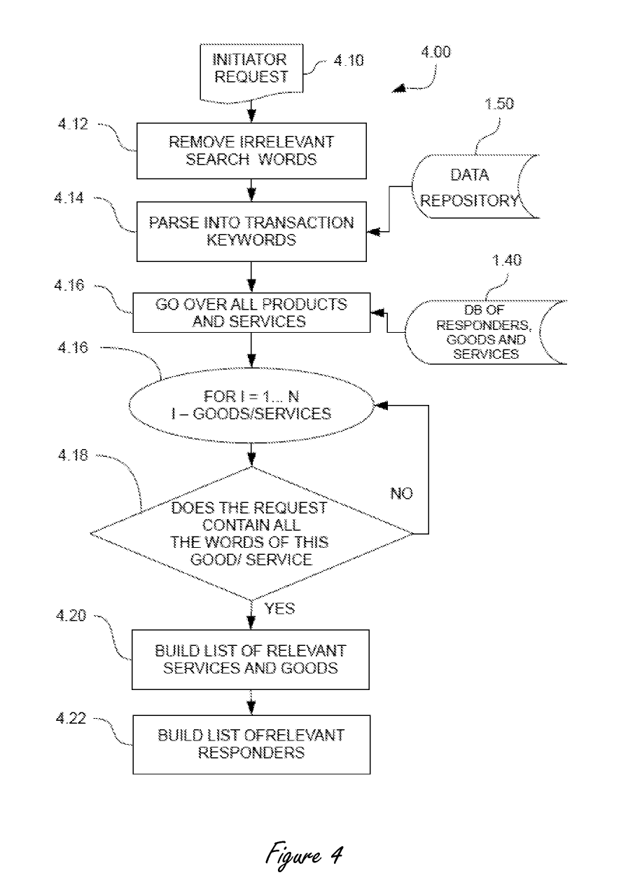

Referring now generally to the figures and particularly to FIG. 4. FIG. 4 shows a sequence of the transaction meditation algorithm processed by the transaction mediation module of FIG. 1.

Upon any initiator request, the transaction mediation algorithm is initiated. The initiator request is processed with algorithms that extract the meaning of the request and identify the good/services that the initiator has demanded.

First irrelevant search words are removed as per step 4.12 and the request is parsed into transaction keywords as per step 4.14, with the help of the data repository 1.50. Next a search is performed to find the appropriate goods/services as per step 4.16 matching the initiator request, a list of relevant goods/services with matching qualifiers is built as per step 4.20 and then the list of relevant responders who offer such good/services with appropriate qualifiers is built, with the help of the database of responders, products and services 1.40.

Referring now generally to the figures and particularly to FIGS. 5-18, illustrating screen shots of the present invention.

In this example, the initiator is a buyer and the responders are sellers.

The screen shot displayed at FIG. 5 is initiated by a buyer which is willing to look at his requests. Each request appears with the number of offers, and the best price.

When the buyer is selecting “offers”, the GUI will display for each seller that enters an offer, the details of the offer, in that case, related to “ IPhone 6S Back 16G for my daughter”, as displayed at FIG. 6. Each seller is marked with a reliability blue wheel 602 associated to the reliability of the seller. The green icon 604 signifies that a chat occurred between the seller and the buyer. There is a limit on the number of offers—the system is limited to 30 offers—the purpose is not to overload the buyer with too much information.

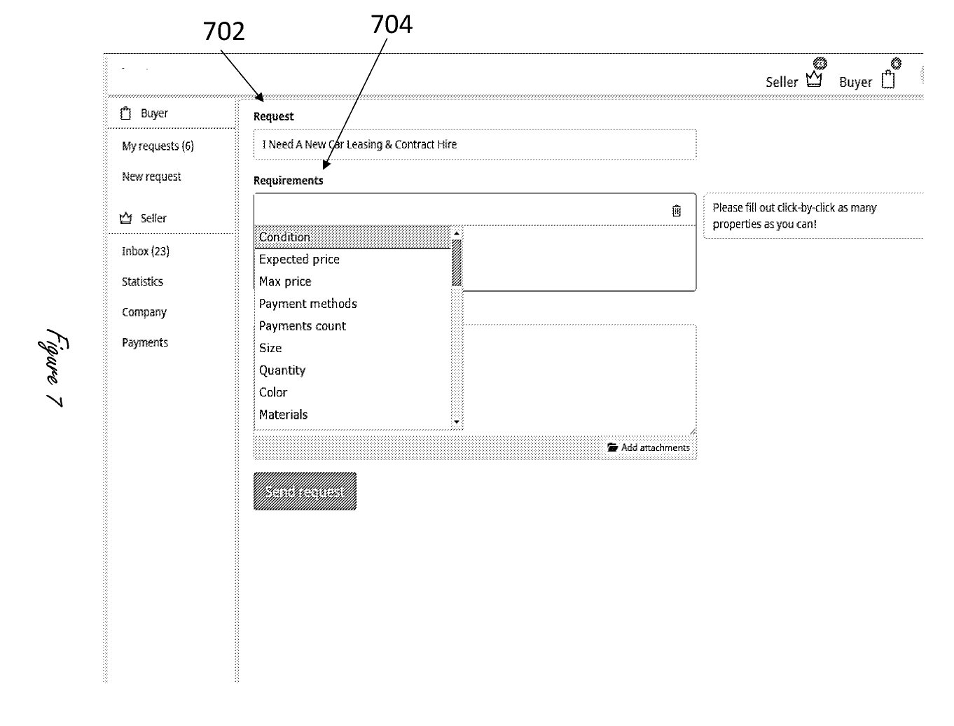

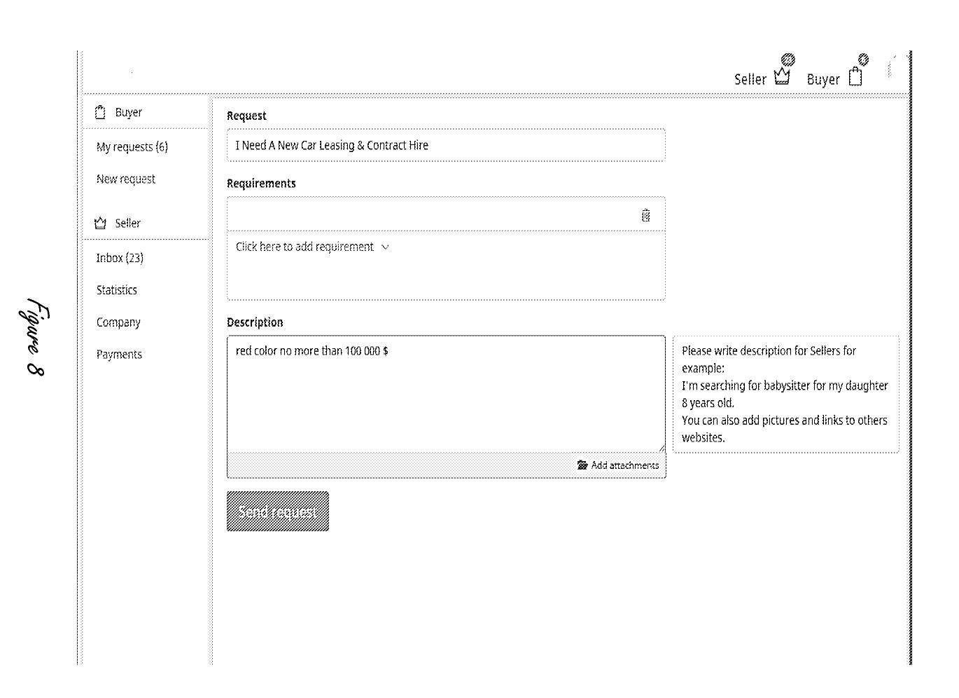

FIG. 7-FIG. 8 represent screen shot appearing in case the buyer inserts a new request 702 in natural language. FIG. 7 illustrates the new request and additional details associated to this new request. FIG. 8 illustrates a description of the new request added by the buyer.

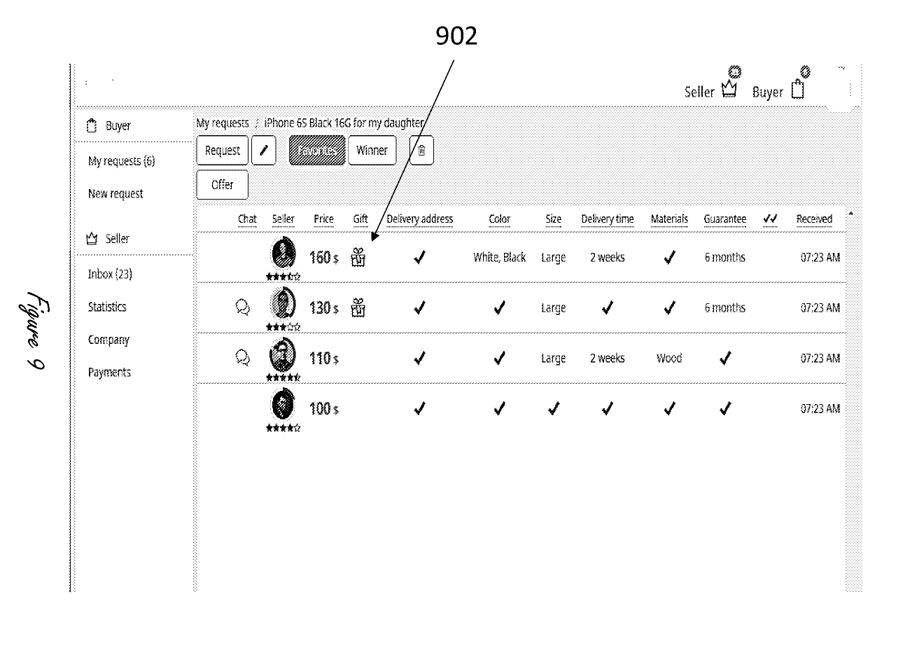

FIG. 9 illustrates a screen shot in case the buyer is willing to take a look on his favorites associated to his previous requests—some of the sellers offer a gift as part of the deal 902.

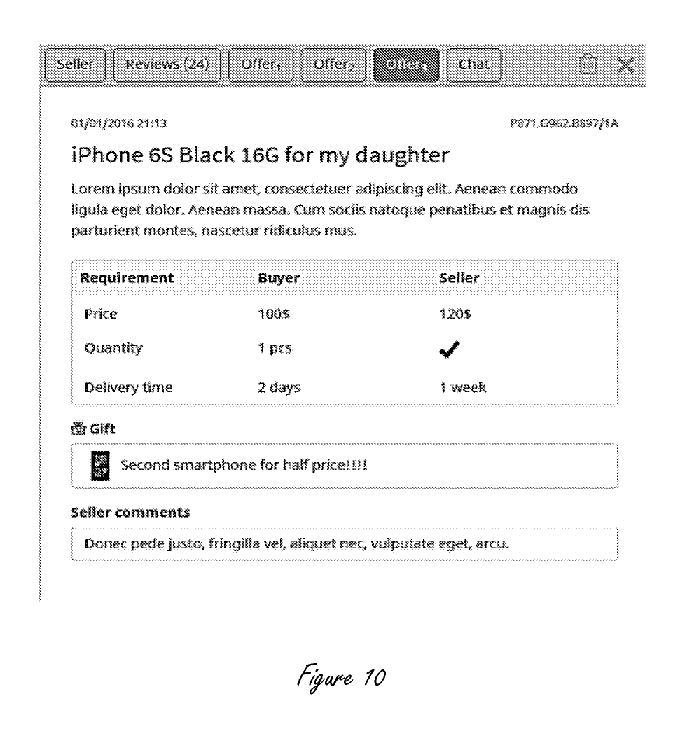

FIG. 10 illustrates a screen shot associated with the third offer that the buyer receives for “IPhone 6S Black 16G for my daughter” with details of the deal from the seller.

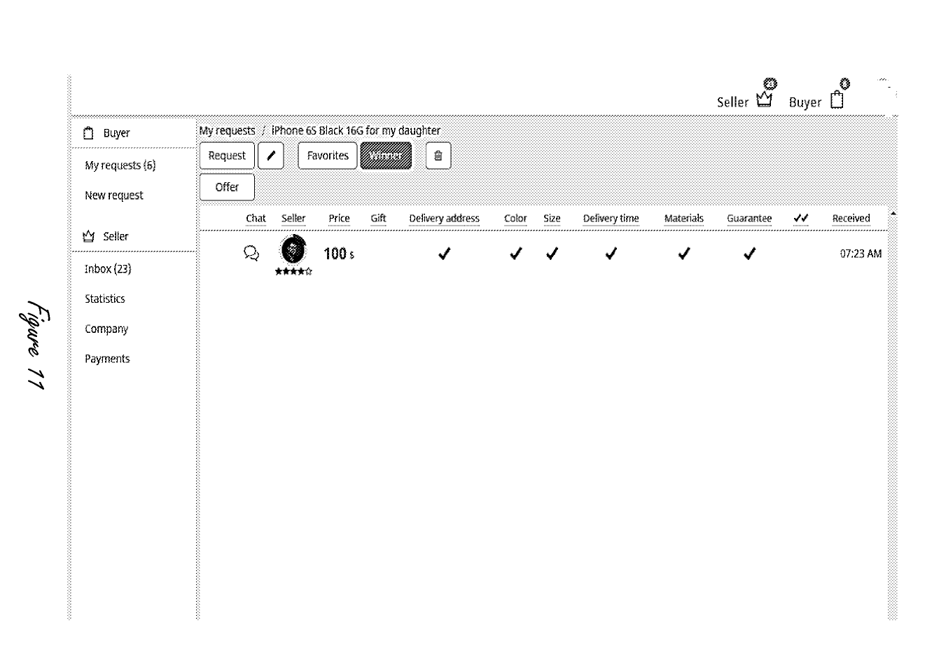

FIG. 11 illustrates a screen shot associated with the winner associated to the buyer's request for “IPhone 6S Black 16G for my daughter”.

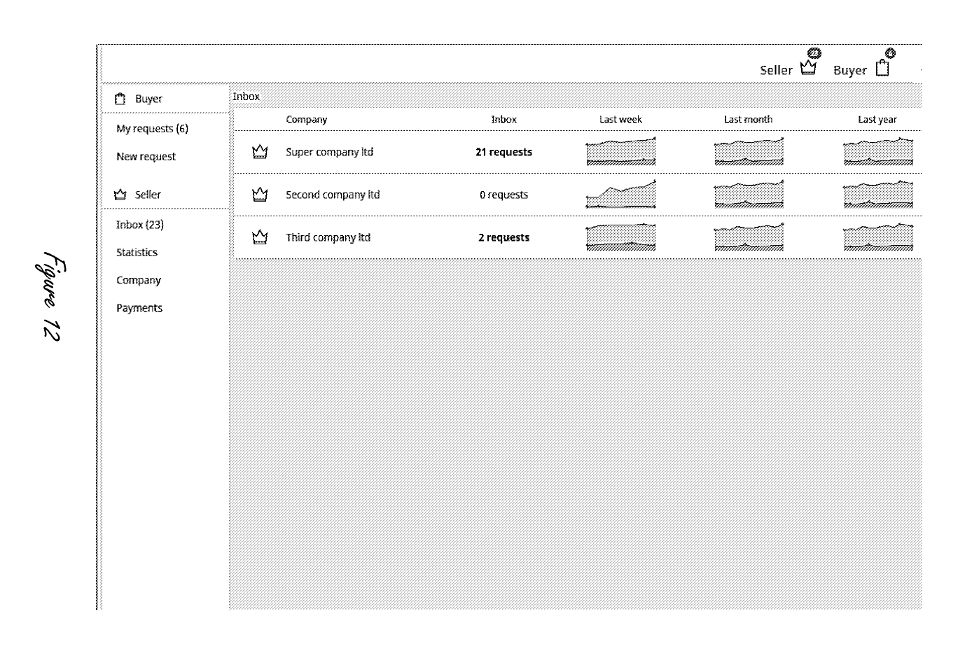

FIG. 12 illustrates a screen shot showing how many requests to which company happen.

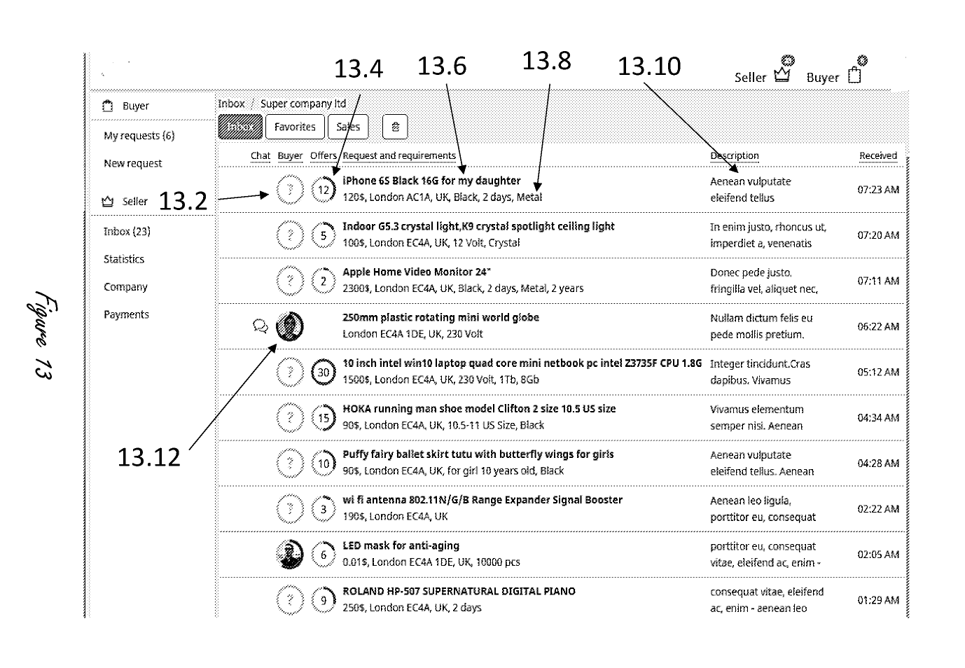

FIG. 13 illustrates a screen shot representing for each buyer, how many offers for each of his requests, e.g. first buyer 13.2 requests for “ IPhone 6S Black 16G for my daughter”, gets 12 offers 13.4, with description 13.8.

A buyer also is associated with a reliability wheel 13.12. The reliability wheel associated to an initiator is based on a number of criteria such as the number of times he really accepts responders offers, how many times the initiator clicks to get an offer and didn't accept any offer.

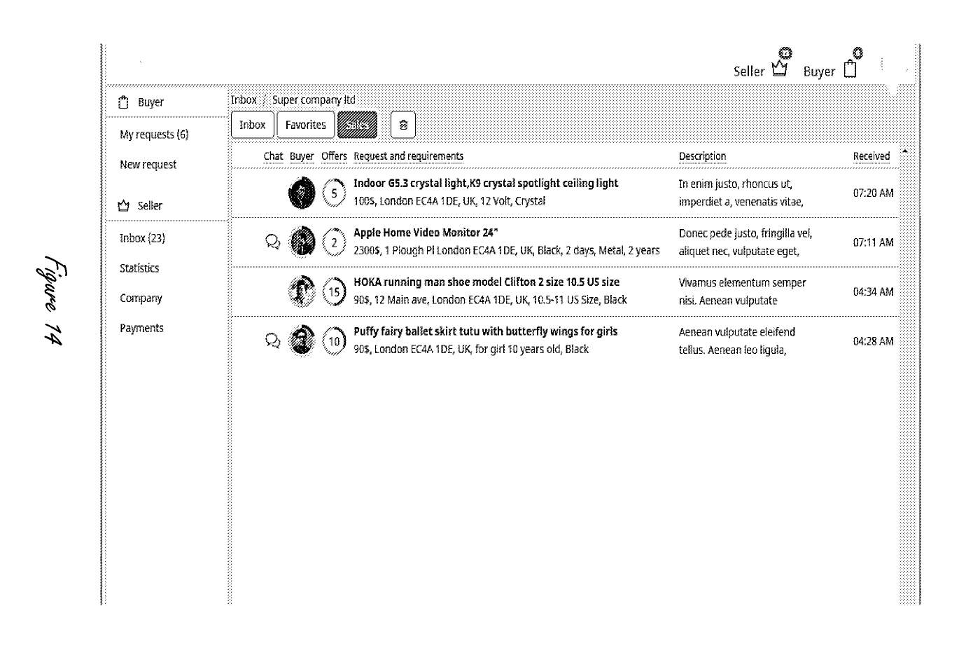

FIG. 14 illustrates a screen shot associated with companies and some details about these companies.

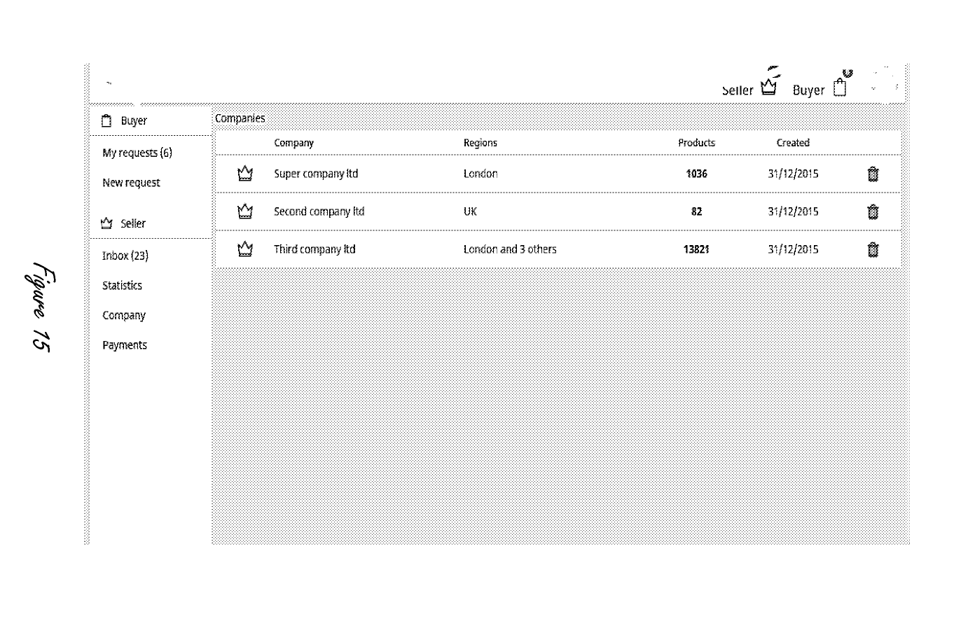

FIG. 15 illustrates a screen shot associated with the sales for one of companies presented at FIG. 14 “Super Company LTD”.

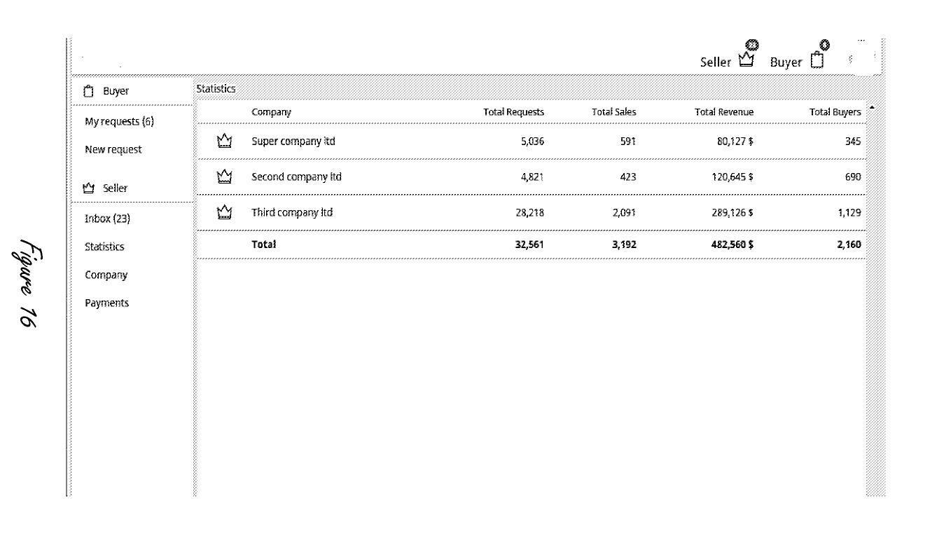

FIG. 16 illustrates a screen shot associated with the statistics for each these companies.

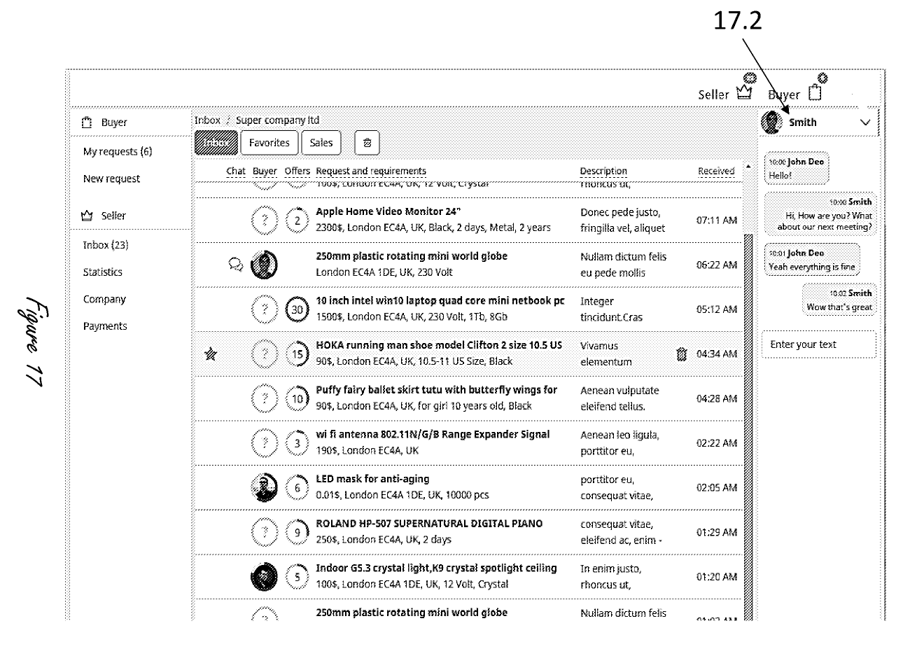

FIG. 17 illustrates a screen shot displaying a chat example between seller/buyer 17.02.

1. A system for automatically matching at least two potential parties to a transaction proposal, said parties comprising an initiator and at least one responder; said system comprising:
a. at least one transaction mediation module for providing transaction mediation services, each transaction mediation module comprising digital data processing means, inter-parties communication means and digital data memory storage;
b. a non-transitory computer readable medium for storing programmed instructions for implementing a transaction mediation algorithm for instructing said at least one transaction mediation module; and
c. a transaction response database of potential responders and potential responder qualifiers, said potential responder qualifiers comprised of categories of data which are relevant for matching a potential responder to a transaction proposal; and
d. a data repository which is a knowledge base including definitions of goods/services and associated structured data including qualifiers of said goods;
wherein said at least one transaction mediation module is configured by said transaction mediation algorithm to implement:
i. a graphic interface module displaying various user interfaces provided to said initiator and responder;
ii. a registration module to receive a registration request from said initiator and registration request from said responder and authenticate them;
iii. a transaction request receiving module for receiving a transaction request from said initiator, said transaction request comprising a description of goods or services for procurement;
iv. a transaction request interpretation module for parsing said transaction request made in natural language into transaction keywords for identifying
a. specific goods or services; and
b. qualifiers of said goods or services;
v. a transaction request matching module for compiling a request provision list from said data repository database, said request response provision list comprised of matching goods or services computed to match said description of said transaction request;
vi. a transaction request responder module for compiling a responder list from said transaction response database, each entry of said responder list comprised of (a) an identification of a potential responder computed to be capable of providing said matching goods or services, and (b) one or more potential responder qualifiers computed to be relevant to said transaction request; and,
vii. a transaction reply module for composing and communicating a transaction request reply to said initiator, said transaction request reply comprising information elements from said responder list.

2. The system according to claim 1, wherein the initiator is a buyer and the responder is a seller.

3. A method for automatically matching at least two potential parties to a transaction proposal, said parties comprising an initiator and at least one responder; said method comprising:
a. providing a data repository which is a knowledge base including definitions of goods/services and associated structured data including qualifiers of said goods;
b. providing a transaction response database of potential responders and potential responder qualifiers said potential responder qualifiers comprised of categories of data which are relevant for matching a potential responder to a transaction proposal;
c. displaying various user interfaces provided to said initiator and said responder, by employing a graphical interface module;
d. registering said initiator and said responder after, authenticating them, by employing a registration module;
e. transforming a transaction request made in natural language into a set of structured data in said data repository by employing a transaction request receiving module, a transaction request interpretation module wherein said transaction request receiving module receives a transaction request from said initiator, said transaction request comprising a description of goods or services for procurement and wherein said transaction request interpretation module parses said transaction request made in natural language into transaction keywords for identifying
a. specific goods or services; and
b. qualifiers of said goods or services;
f. compiling a request provision list, computed to match said description of said transaction request thanks to a transition request matching module and said data repository database;
g. compiling a responder list wherein each entry of said responder list comprised of (a) an identification of a potential responder computed to be capable of providing said matching goods or services, and (b) one or more potential responder qualifiers computed to be relevant to said transaction request, by employing a transaction request responder module and said transaction response database; and,
h. composing and communicating a transaction request reply to said initiator by employing a transaction reply module, wherein said transaction request reply is comprising information elements from said responder list.

4. The method according to claim 3, wherein the initiator is a buyer and the responder is a seller.

5. A non-transitory computer-readable medium with instructions stored thereon, that when executed by a processor, performs the steps comprising:
a. displaying various user interfaces provided to said initiator and said responder by employing a graphical interface module;
b. registering said initiator and said responder after authenticating them, by employing a registration module;
c. transforming a transaction request made in natural language into a set of structured data by employing a transaction request receiving module, a transaction request interpretation module wherein said transaction request receiving module receives a transaction request from said initiator, said transaction request comprising a description of goods or services for procurement and wherein said transaction request interpretation module parses said transaction request made in natural language into transaction keywords for identifying
specific goods or services; and
qualifiers of said goods or services;
d. compiling a request provision list, computed to match said description of said transaction request, by employing a transition request matching module and said data repository database;
e. compiling a responder list wherein each entry of said responder list is comprised of (a) the identification of a potential responder computed to be capable of providing said matching goods or services, and (b) one or more potential responder qualifiers computed to be relevant to said transaction request, by employing a transaction request responder module and a transaction response database; and
f. composing and communicating a transaction request reply to said initiator by employing a transaction reply module, wherein said transaction request reply is comprising information elements from said responder list.
